(19) United States
(12) Patent Application Publication
(10) Pub. No.: US 2011/0058467 A1
(43) Pub. Date: Mar. 10, 2011

(54) High-Density Optical Storage Structure

(75) Inventor: Joseph Pichon, Grenoble (FR)

(73) Assignees: SOCIETE DES MOULAGES PLASTIQUES DE L'OUEST, Averton (FR); Commissariat a L'Energie Atomique et aux Energies Alternatives, Paris (FR)

(21) Appl. No.: 12/921,162

(22) PCT Filed: Feb. 27, 2009
(86) PCT No.: PCT/EP2009/052355

§ 371 Date: Nov. 23, 2010

(30) Foreign Application Priority Data
Mar. 7, 2008 (FR) 08 01270

(51) Int. Cl. G11B 7/24

(52) U.S. Cl. 369/275.4; G9B/7.139

(57) ABSTRACT

The present invention relates to a high-density optical data storage structure. The structure comprising a substrate provided with physical marks, said physical marks being covered by at least one active layer, the physical state of the active layer being modified when irradiated by a laser beam, the substrate consisting of adjacent tracks that are alternately recessed and protruding, the physical marks consisting of pits in the land tracks and of bumps in the groove tracks. The invention is applicable, notably, to the production of high storage capacity optical disks and more particularly to the production of prerecorded optical disks.

The present invention relates to a high-density optical storage structure. It is applicable, notably, to the production of high storage capacity optical disks and more particularly to the production of prerecorded optical disks.

To simplify the following description, the storage medium described will be an optical disk.

Conventionally, a prerecorded optical disk comprises a substrate, often made of a polycarbonate that, so as to store data, is molded with physical marks that may take the form of variably sized bumps or pits. The physical marks are grouped along virtual tracks separated from each other by a contain distance. The read system for such a disk comprises an objective lens which focuses a laser beam onto the plane of the disk, thus forming a focused laser spot the size of which is approximately equal to the quotient of the wavelength λ of the beam divided by the numerical aperture NA of the objective lens. The spot size (λ/NA) imposes a resolution limit which, in theory, prevents marks smaller than λ/4NA from being read.

The desire to transcend this limit, so as to produce higher recording density optical media has led to so called super-resolution techniques being employed.

These techniques are based on the nonlinear optical properties of certain materials. The term “nonlinear properties” is understood to refer to the fact that certain optical properties of the material change depending on the intensity of the illuminating light. Thermal, optical, thermooptical and/or optoelectronic effects, caused by the read laser itself, locally modify the optical properties of the material at scales smaller than the size of the laser read spot; because the property changes, data present in this very small volume becomes detectable whereas it would not have been detectable without this change.

The phenomenon exploited is principally based on two properties of the read laser that will be used:
on the one hand, the laser is very tightly focused, so as to have an extremely small cross section (of the order of the wavelength) but the cross-sectional power distribution is Gaussian, i.e. very high at its center and very attenuated at the periphery; and
on the other hand, a laser read power is chosen such that the power density in a small part of the cross section, i.e. in the center of the beam, substantially modifies the optical properties of the layer, whereas the power density outside this small portion of the cross section does not substantially modify these properties. The optical properties are modified in a way that tends to enable data that would be unreadable without this modification to be read. For example, the changes in optical properties may result in a transmissivity increase.

When a data bit consists of a physical mark formed on the optical disk, this mark structuring the nonlinear layer that covers it, the response of the layer to being struck by the laser beam may be, without preference, a transmissivity increase or a reflectivity increase; this increase occurs at the center of the laser beam and not at the periphery, because of the nonlinearity. It is then as though a beam focused on a diameter much smaller than the wavelength-imposed limit had been used.

Various theoretical proposals for implementing these principles have been put forward, but not one has given rise to an industrial development. Patent U.S. Pat. No. 5,153,873 reviews the theory. Patent U.S. Pat. No. 5,381,391 gives an example of a film having nonlinear reflectivity properties. Patent U.S. Pat. No. 5,569,517 provides various crystalline phase-change materials.

Among currently known techniques, the most promising uses a layer of platinum oxide (PtOₓ) sandwiched between two layers of a zinc sulfide-silicon oxide compound, the whole assembly being inserted between two layers of an AgInSbTe or GeSbTe compound and this assembly again being inserted between layers of zinc sulfide/silicon oxide compound. The AgInSbTe or GeSbTe material changes phase when illuminated with intense laser light. Examples may be found in Applied Physics Letters, Vol. 83, No. 9, September 2003, Jooho Kim et al. “Super-Resolution by elliptical bubble formation with PtOₓ and AgInSbTe layers” and in Japanese Journal of Applied Physics, Vol. 43, No. 7B, 2004, Jooho Kim et al. “Signal Characteristics of Super-Resolution Near-Field Structure Disk in Blue Laser System” and, in the same review, Duseop Yoon et al. “Super-Resolution Read-Only Memory Disc Using Super-Resolution Near-Field Structure Technology”.

The structures described in these articles are based principally on the formation of bubbles by expansion of the platinum oxide, the enclosing layers trapping them. These bubbles are formed with a write laser and may be recognized during readout, even at read laser wavelengths of several times the size of the bubbles.

A prior patent application, FR 0700938, owned by the applicant thus proposes to use as a super-resolution storage structure a superposition comprising a layer of indium antimonide or gallium antimonide inserted between two dielectric layers of a zinc sulfide-silicon oxide (ZnS—SiO₂) compound.

Very small and closely spaced physical marks may then be recorded. For example, marks having a size (length and width) of 100 nm or less, that is to say four to five times smaller than the read wavelength of a blue laser, i.e. typically approximately 400 nanometers, may be recorded and subsequently read. The data density may thus be increased by a factor of approximately 3 relative to media conforming to the BD (“Blu-Ray Disc”) standard.

This technique is therefore very advantageous. However, although this technique allows the marks to be placed much closer together in the direction of travel of the marks beneath the read laser, it has been observed that it is not possible to place marks as close together in the direction perpendicular to the direction of travel, that is to say that the distance between tracks may not be reduced by as much as the distance between marks.

Because the very principle of super-resolution consists in using a read laser beam that is larger than the marks, the peripheral part of this laser beam naturally illuminates the marks in neighboring tracks. This illumination, even if it is not enough to modify the properties of the active layer of the marks in the neighboring track, nevertheless produces a reflected signal creating a certain amount of crosstalk that interferes with the signal produced by the marks of the track being read.

In addition, increasing the density of tracks leads to tracking errors that make the disk difficult if not impossible to read.

One object of the invention is to increase the density of data stored on an optical medium without making the data stored harder to read. To this end, one of the subjects of the invention is a high-resolution optical data storage structure comprising a substrate provided with physical marks, said physical marks being covered by at least one active layer having reversible nonlinear optical properties that enable super-resolution readout, it being possible to modify the properties of the active layer locally by the action of a small central portion of a read laser beam, the structure being characterized in that the substrate is composed of adjacent tracks that are alternately groove and land tracks, the physical marks consisting of pits in the land tracks and bumps in the groove tracks. Advantageously, the substrate is made of a polycarbonate.

Combining a structure consisting of grooves and lands with the use of an active layer designed to produce a super-resolution effect notably causes a drastic reduction in the increased crosstalk inherent in the principle of reading with a laser beam that is wider than the physical marks to be read.

According to one embodiment, when the read laser is a blue laser of approximately 400 nm wavelength, the distance separating the centers of two adjacent tracks is between 240 nanometers and 320 nanometers, the structure according to the invention providing good readout performance notably at 240 nanometers.

According to one embodiment, the length of each of the physical marks is between twice an elementary length T and 9T. The marks have a width preferably equal to or slightly greater than 2T. The value of T (approximately 25 nanometers) is very much less than the equivalent value in disks currently recorded in accordance with the BD standard (70 to 80 nanometers).

The invention is applicable to the production of high storage-capacity optical disks.

Other features of the invention will become clear on reading the following detailed description given by way of nonlimiting example and with reference to the appended drawings which show:

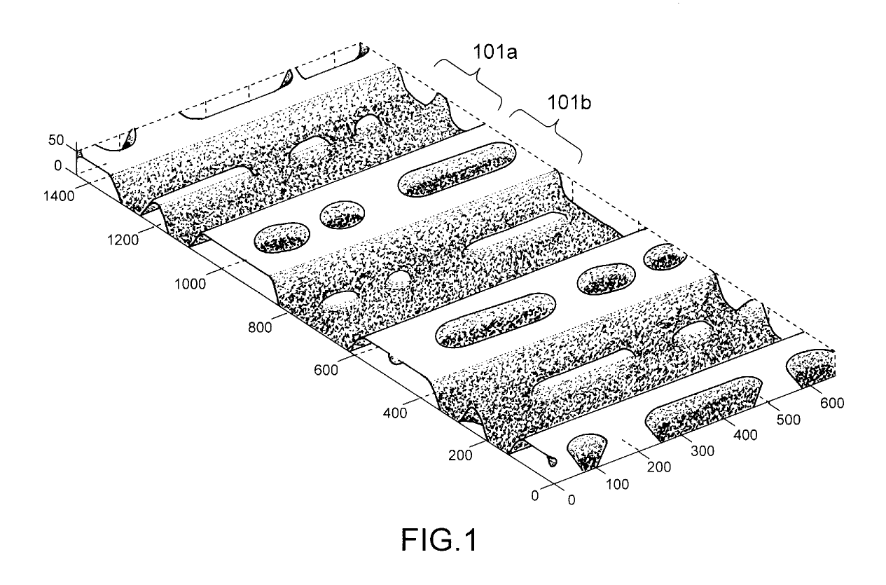

FIG. 1, a close-up perspective view of an optical disk provided with a storage structure according to the invention;

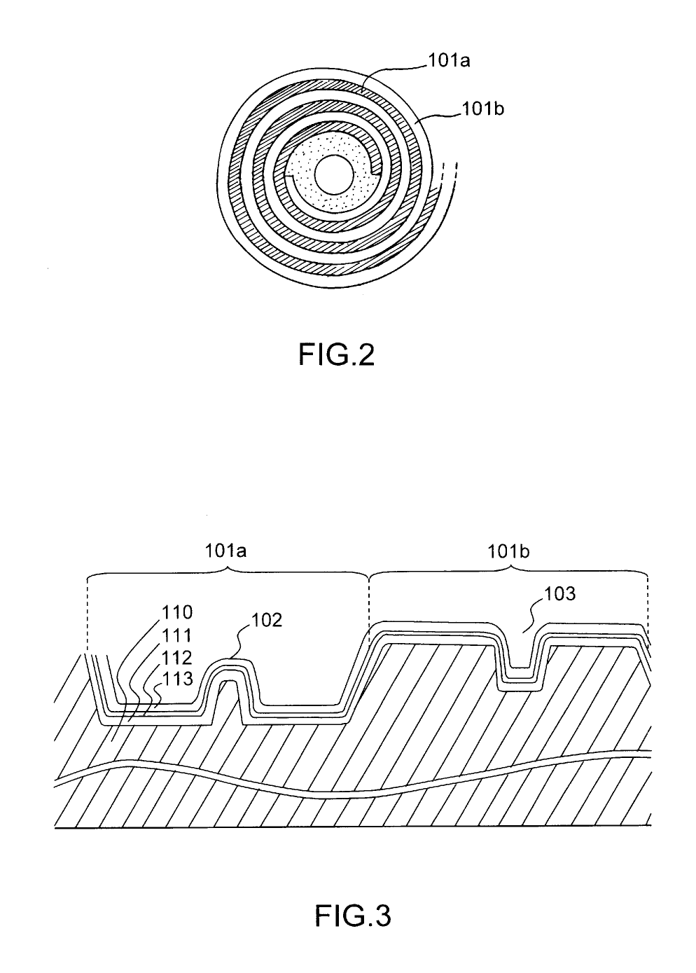

FIG. 2, a close-up top view of a disk portion provided with a storage structure according to the invention; and

FIG. 3, a close-up cross-sectional view of a storage structure according to the invention.

FIG. 1 shows a close-up perspective view of a section of an optical disk provided with a storage structure according to the invention.

The disk structure consists of a juxtaposition of tracks substantially perpendicular to the radius of the disk, each of these tracks being alternately raised and lowered. More precisely, a first lowered track 101a forms a groove and a second track 101b, adjacent to the first track 101a, forms a land in the example having a height H equal to 50 nanometers relative to the first track 101a. The groove-land pattern formed by the two adjacent tracks 101a, 101b is repeated along the length of a radius of the disk, so that an alternation between a groove track 101a and land track 101b occurs across the entire width occupied by the tracks.

FIG. 2 shows a close-up top view of a disk portion provided with a storage structure according to the invention. In the example of FIG. 2, the disk consists of two adjacent spirals 101a, 101b, one corresponding to a groove and the other to a land. The two spirals are intercoiled so that a radial juxtaposition of two grooves or two lands is impossible.

FIG. 3 shows a close-up cross-sectional view of a storage structure according to the invention. The substrate 110, the surface of which is made up of alternating etched grooves and lands and of a pattern of marks etched in the grooves and in the lands, is covered with an optically nonlinear multilayer stack, hereafter more simply denoted by “active multilayer”, which, in the example, consists of three thin-film layers 111, 112 and 113. The first layer 111 and the third layer 113 are dielectrics whereas the second layer 112 sandwiched between the first layer 111 and the third layer 113 is an active layer. More precisely, the transmissivity or reflectivity of this second layer 112 increases nonlinearly when irradiated by a sufficiently powerful laser beam, an average laser beam power being chosen such that only the power density at the center of the beam causes this change.

So as to avoid introducing an asymmetry into the structure, the full width at half-maximum of the groove tracks has been chosen to equal the full width at half-maximum of the land tracks. Moreover, data is recorded onto the disk via physical marks that are produced differently, depending on whether they are formed in a groove track or in a land track. On the groove tracks the physical marks are protrusions in the form of bumps 102, whereas on the land tracks the physical marks take the form of pits 103.

In the example shown in FIG. 3, the height of the bumps 102 above the grooves and the depth of the pits 103 beneath the lands are near the mid-height of the land tracks 101b. In another embodiment, the height of the bumps 102 present on the groove tracks 101a is chosen to equal the height of the land tracks 101b, and the depth of the pits 103 formed in the land tracks 101b reaches the level of the groove tracks 101a.

The length of each physical mark 102, 103 in the tangential direction, that is to say in the direction of travel of the marks, is a multiple of an elementary length T and varies, in the example, between 2T and 9T. By way of illustration T is equal to 25 nanometers, compared to a length T for the conventional 23.3 Gbyte BD format is equal to 80 nanometers, so that, in this configuration, the smallest physical marks (of length 2T) measure 50 nanometers (compared to 160 nanometers for the BD standard) and the largest marks (of length 9T) measure 425 nanometers (compared to 720 nanometers for the BD standard).

Moreover, the full width at half-maximum of each of the physical marks 102, 103 in the radial direction, perpendicular to the direction of travel, is less than the full width at half-maximum of the groove and land tracks 101a and 101b. In the example, this full width at half-maximum of the physical marks is chosen to equal the length at half-maximum of the marks of length 2T. According to another embodiment, the physical marks of length 2T are slightly elongated in the radial direction, the full width at half-maximum of each of the physical marks being slightly greater than their length, for example from 10% to 30% greater, the signal-to-noise ratio of these small marks being thus improved.

Moreover, the land/groove structure ensures a satisfactory push-pull signal. A good push-pull signal may notably be obtained with an intertrack separation distance of between 160 nanometers and 320 nanometers, the tracking obtained being equally satisfactory when the laser spot of the read head is focused on a land track as when it is focused on a groove track.

Furthermore, the super-resolution effect, which produces a local and reversible increase in the reflectivity of the stack of layers 111, 112, 113 beneath the focused laser spot, has almost no influence on the push-pull signal and it therefore does not interfere with the tracking of the land-groove structure.

On the one hand, experiments show that the signal originating from sequence of pits 103 on the land tracks 101b is comparable to the signal obtained from the bumps 102 on the groove tracks 101a, and particularly in the case of marks smaller than the resolution limit, the latter requiring a super-resolution effect to be detected.

On the other hand, the crosstalk phenomenon, accentuated by increasing the density of the tracks, remains sufficiently low during readout of a disk structured according to the invention that the signal-to-noise ratio is not reduced during readout, this being equally true at a low read power, in other words without the super-resolution effect, as at a high read power, that is to say at super-resolution powers.

Thus, sequences of physical marks formed on a prerecorded land/groove structure, said physical marks being compact in both the radial and tangential directions, may be read with a similar performance to that obtained from conventional disks. Notably, when the tracks 101a and 101b are separated in the radial direction by a separation distance of between 200 nanometers and 320 nanometers, the readout performance of the structure according to the invention is satisfactory. In particular, experiments have shown that the super-resolution readout performance, notably from the point of view of crosstalk and of signal-to-noise ratio, of a disk structured according to the invention—the track separation distance of which is 240 nanometers—is equally as good as that obtained during super-resolution readout of a disk without a land/groove structure—having a track separation distance of 320 nanometers.

By way of illustration, satisfactory readout performance is notably obtained by using:
∘ an optical read head provided with a blue laser of wavelength equal to 405 nm and a numerical aperture equal to 0.85, corresponding to a resolution limit of approximately 120 nanometers;
∘ tracks separated by a distance of 240 nanometers, 50 nanometers high lands, the slope of the sides passing from land to groove being 60°;
∘ physical marks of 50 nanometer size (i.e. height of the bumps and depth of the pits) of a length at half-maximum varying from 2T=50 nanometers to 9T=425 nanometers and of a width at half-maximum equal to 50 nanometers for all the marks (from 2T to 9T); and
∘ an active multilayer, the origin of the super-resolution effect, that produces a low-power reflectivity equal to 22% and a high-power reflectivity equal to 44%.

Among the advantages of using, in the structure according to the invention, an active thin-film multilayer having optical properties that change nonlinearly and reversibly when irradiated with a high-power laser beam, the following may notably be mentioned:
∘ the detection of a signal emitted by small prerecorded marks is made possible whether these marks are formed on a groove or on a land;
∘ the crosstalk phenomenon is reduced and therefore the read signal-to-noise ratio of the track is improved; and
∘ a push-pull signal, sufficient for satisfactory tracking to be carried out, is maintained.

1. A high-resolution optical data storage structure comprising a substrate provided with physical marks, said physical marks being covered with at least one active layer having reversible nonlinear optical properties enabling super-resolution readout, through the action of a small central portion of a read laser beam, wherein the substrate is composed of adjacent tracks that are alternately groove and land tracks, the physical marks consisting of pits in the land tracks and bumps in the groove tracks.

2. The structure as claimed in claim 1, wherein the distance separating the centers of two adjacent tracks is between 240 nanometers and 320 nanometers.

3. The structure as claimed in claim 1, wherein the length of each of the physical marks is an integer multiple of an elementary length T said integer multiple being comprised between 2 and 9, wherein marks of length 2T have a full width equal to or slightly greater than their length.

4. The structure as claimed in claim 1, wherein the substrate is made of a polycarbonate.

5. The structure as claimed in claim 1 incorporated in a high storage capacity optical disk.

6. The structure as claimed in claim 2, wherein the length of each of the physical marks is an integer multiple of an elementary length T said integer multiple being comprised between 2 and 9, wherein marks of length 2T have a full width equal to or slightly greater than their length.

7. The structure as claimed in claim 2, wherein the substrate is made of a polycarbonate.

8. The structure as claimed in claim 2, incorporated in a high storage capacity optical disk.

9. The structure as claimed in claim 3, wherein the substrate is made of a polycarbonate.

10. The structure as claimed in claim 3, incorporated in a high storage capacity optical disk.

11. The structure as claimed in claim 4, incorporated in a high storage capacity optical disk.
